(19) United States
(12) Patent Application Publication
(10) Pub. No.: US 2011/0220039 A1
(43) Pub. Date: Sep. 15, 2011

(54) HYDROLYSIS SYSTEM TO PRODUCE HYDROGEN-OXYGEN GAS AS A FUEL ADDITIVE FOR INTERNAL COMBUSTION ENGINES

(76) Inventors: Richard Nowicki, Alhambra, CA (US); James J. Herzstock, Santa Clarita, CA (US); Blake Spurgin, Palm Springs, CA (US); Joseph Dragan, Alhambra, CA (US)

(21) Appl. No.: 12/719,872

(22) Filed: Mar. 9, 2010

(51) Int. Cl. F02B 43/08; C25B 9/00; C25B 1/02

(52) U.S. Cl. 123/3; 204/278; 205/637

(57) ABSTRACT

Internal combustion engines operate by igniting a mixture of liquid fuel and air inside its combustion chamber. The energy from the ignition is converted to mechanical energy that is used to power a vehicle. Research indicates that adding hydrogen gas into the combustion chamber improves the efficiency of the engine. The present invention is an electrolysis system that produces hydrogen and oxygen gases and injects them into the fuel line of the engine to create a mixture of the gases and the liquid fuel that is subsequently introduced into the combustion chamber for ignition. The operating temperature of the engine is lower if the gases are injected into the fuel line rather than directly into the combustion chamber.

### BACKGROUND OF INVENTION

1. Field of Invention

The present invention is related to an apparatus and method of improving the fuel efficiency of an internal combustion engine, while improving the engine efficiency and reducing at least one toxic by-product from its combustion, and in particular, to an apparatus and method of hydrolyzing water into a mixture comprising hydrogen gas and oxygen gas to be mixed with the liquid fuel used in an internal combustion engine.

2. Description of Prior Art

The efficiency of internal combustion engines has improved significantly over the last few years while reducing toxic emissions. However, government regulations continue to force engine manufacturers to constantly seek improvements. This has spurred development of alternate fuel technologies such as electric engines, natural gas and propane fueled engines, hydrogen cell engines, and the like. While a number of these technologies are promising, some are still a long way from commercial implementation, and others appear to have reached the limit of present design capabilities without yielding a consumer acceptable product. Therefore, attention has refocused on conventional gasoline and diesel burning engines, and ways to render them more efficient and less polluting.

A major problem with conventional gasoline and diesel burning engines is the production of toxic emissions such as carbon monoxide, nitrous oxides, sulfur dioxide, and other noxious gases. These toxic substances are often a result of the engine not completely burning its fuel.

Hydrogen, however, releases more energy than conventional gasoline and diesel, it produces only water as the product of combustion, and it can readily be produced from water by electrolysis. But despite its advantages, hydrogen is highly explosive and requires significant caution when using it in an engine.

Research has proven that mixing hydrogen gas with gasoline or diesel in an internal combustion engine produces improved efficiency and a reduction in emissions of pollutants. These benefits are thought to be the result of more complete combustion induced by the presence of hydrogen.

One way to use hydrogen gas in an engine is to store the gas in tanks installed in the vehicle, with hoses connecting the tanks to the engine. However, tank storage of hydrogen gas presents a safety hazard, since there is a risk of a gas leak and explosion. It also requires periodic replenishment of the hydrogen gas in the tank, which is inconvenient and dangerous. As a result of these problems with tank storage, various attempts have been made to develop systems in which the gas is generated on-board the vehicle itself for use by the engine as needed.

One way to produce hydrogen gas for use by an engine is through an electrolysis system. Electrolysis is the decomposition of water into its components of hydrogen gas and oxygen gas by passing an electric current therethrough. The design of the electrolysis system is limited by the type of internal combustion engine with which it is used. For example, the combustion cycle of diesel engine varies from that of a gasoline engine. In a gasoline engine, all of the products of hydrolysis are fully combustible and may be combusted in place of fuel. The hydrogen-oxygen mixture basically replaces the fuel-air mixture and the performance is maintained. However, to produce a sufficient amount of hydrogen and oxygen through electrolysis to run a gasoline engine is difficult with a small electrolysis unit. In a diesel engine, on the other hand, if too much hydrogen-oxygen mixture is injected into the engine, the free oxygen needed for combustion would be displaced. Any excess oxygen and hydrogen is not a solution in a diesel engine unless the quantities are controlled and optimized for diesel engine enhancement. Finally, concerns of designing an electrolysis system for use in an internal combustion engine also include safety, reliability, required maintenance, required electricity, and volume of gases produced.

An example of an electrolysis system used to add hydrogen gas and oxygen gas to an internal combustion engine is taught in U.S. Pat. No. 6,209,493. This system produces hydrogen gas and oxygen gas that may either be separated or mixed before the gases are introduced into the engine. However, this system has electrodes that do not have a very high surface area. Hydrogen gas and oxygen gas can be produced more efficiently with electrodes having greater surface area. More important, the hydrogen and oxygen gases produced by this system are injected into the engine through the air intake.

U.S. Pat. No. 5,231,954 provides another electrolysis system for generating hydrogen and oxygen gases on-board a vehicle. This system injects the hydrogen and oxygen gases into the engine through the positive crankcase ventilation (PCV) system. When the engine is running, a vacuum is created in the PCV line which is used to draw the gases out of the electrolysis system and into the engine. There is an air intake adjustment valve that is always open to the atmosphere. This valve is adjusted to mix air with the generated gases so as to meet emission control regulations. The unit has a friction-fit cap that secures tightly when exposed to the PCV line vacuum, and loosens when the engine and associated vacuum is turned off. The loose cap is intended to pop off to provide relief from high pressure build-up in the unit when the engine is turned off.

Another example of an electrolysis system is taught by U.S. Pat. No. 3,939,806. This system is complicated but includes a mechanism to generate DC current to power itself. This requires a working fluid such as water or Freon and accompanying circulation system, a turbine and DC generator, a hydrogen carburetor and hydrogen storage tank, and several pumps to move the working fluid, water, and hydrogen. Implementing such a complicated system would be costly, require extensive effort to integrate with existing engines, and likely involve significant maintenance due to the many additional components. Further, the '806 patent does not address the risk of an explosion, particularly from the hydrogen tank.

The problem with introducing the hydrogen and oxygen gases into the engine through the air intake, as in the '493 patent, is the oxygen sensor that is used in all engines to optimize the fuel-air mixture. Normally, if the oxygen sensor senses more oxygen, the vehicle's computer determines that the engine is running lean and opens up the fuel injectors to add more fuel to the fuel-air mixture. The addition of oxygen from the electrolysis system will cause the fuel injectors to add more fuel than needed thus causing poor fuel efficiency. Considerable adjustment of the oxygen sensor controller is required to resolve this issue.

The problem with introducing the hydrogen and oxygen gases into the engine through the PCV vacuum line, as in the '954 patent, is that it fools the engine's control system and causes it to misfire and behave poorly. A typical engine includes a sensor for monitoring input air quality (the “MAP” or mass air pressure sensor) which provides output to a microprocessor which can, for example, adjust the fuel input to the engine accordingly. Additional sensors monitor the combustion outputs. Introducing hydrogen and oxygen gases into the PCV system means that they are put in downstream of the MAP sensor which creates an imbalance. Thus, in some cases, introduction of the gases creates a worse polluting engine. Considerable adjustment of the microprocessor controller is required to resolve this issue.

Another problem shared by many electrolysis systems is overheating of the engine. The high volatility and combustibility of the hydrogen and oxygen gases often result in higher operating temperatures than a typical gasoline or diesel engine is designed to withstand for long periods of time. The injection of the gases through the air intake or PCV results in higher operating temperatures for the engine. At these higher temperatures, various engine components, such as rubber gaskets and hoses, begin to burn or deteriorate at faster rates.

U.S. Pat. No. 6,311,648 teaches an electrolysis system that injects the produced hydrogen and oxygen gases directly into the fuel tank of a vehicle. By injecting the gases into the fuel tank, the '648 patent avoids the issues caused by the oxygen and MAP sensors, as described above. However, adding the gases into the fuel tank prevents the system from optimizing the gases to liquid fuel ratio that is needed by the engine. In the fuel tank the gases and liquid fuel are inefficiently and ineffectively mixed and then sent through a long fuel line into the combustion chamber of the engine. The actual mixture that enters the combustion chamber is not consistent or controllable. Furthermore, as the gases and liquid fuel travel through the long fuel line, the gases tend to separate from the liquid fuel. The lack of a proper mixture of the gases and liquid fuel prevents the system from operating at optimum levels and can create more heat than the engine may be able to withstand. Furthermore, introducing the gases into the fuel tank increases the possibility that the gases will separate from the liquid and collect within the fuel tank. Such accumulation of hydrogen and oxygen gases in the vehicle's fuel tank can be extremely hazardous and may explode at any time.

Unless these and other practical problems associated with this technology are resolved, the improved efficiency and reduced pollution benefits possible from using hydrogen and oxygen gases as fuel additive will fail to be realized.

### SUMMARY OF THE INVENTION

Accordingly, the present invention has been made in view of the above-mentioned disadvantages occurring in the prior art. The present invention is an electrolysis system that can be installed into any vehicle, ship, or aircraft that is powered by an internal combustion engine. The electrolysis system produces hydrogen gas and oxygen gas from water and injects it into the fuel line of the engine so that the gases and the liquid fuel can be properly mixed prior to being injected into the combustion chamber of the engine for ignition.

The electrolysis system of the present invention does not store any significant amount of the unused hydrogen gas and oxygen gas. The system produces the gases as needed by the engine. When the system is turned off, the unused gas is released into the engine or into the atmosphere so that the system does not risk explosion by storing the volatile gases. Sometimes low levels of the gases are left inside the system without risk of explosion.

An embodiment of the present invention has an automatic water refill system to keep the electrolyte solution at the proper levels for efficient hydrogen gas and oxygen gas production. In addition, the present invention has check valves and backflash preventers to reduce the risk of explosion.

It is the object of the present invention to provide an electrolysis system for an internal combustion engine which overcomes the problems associated with the current devices used to generate hydrogen and oxygen gases as a fuel additive for internal combustion engines.

Specifically, it is the object of the present invention to produce sufficient hydrogen gas and oxygen gas to improve the combustion efficiency and reduce toxic emissions of the internal combustion engine to which it is connected. The present invention delivers the generated gases effectively and consistently through the fuel line to the engine, so that the benefits of the gases as a fuel additive are realized.

It is another object of the present invention to be able to operate properly with different types of engines, and particularly with turbocharged diesel engines typically used in commercial trucks that are heavy users of fuel.

It is another object of the present invention to be simple to operate, requiring minimal operator attention and maintenance. Preferably, the invention should require little more than an occasional water refill.

It is another object of the present invention to be easy to install in a vehicle, without requiring extensive engine modification.

It is another object of the present invention to include overlapping safety features to relieve internal gas pressures if the pressure rises above standard operating levels.

The above and other features and advantages of the present invention, as well as the structure and operation of various embodiments of the present invention, are described in detail below with reference to the accompanying drawings.

### DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIG. 1 is a side view of a commercial truck, schematically illustrated in phantom lines, and fitted with the electrolysis system of the present invention to illustrate the essential elements.

FIG. 2 is a perspective view of the electrolysis system of the present invention.

FIG. 3 is a cross sectional view of the electrolysis system of the present invention showing the arrangement of the stainless steel plates, gas accumulation zone, and electrolyte solution.

FIG. 4 is a perspective view of the array of stainless steel plates used in the present invention.

FIG. 5 is a top view of the electrolysis system as it is connected to the fuel line and the internal combustion engine.

FIG. 6 is cross sectional view of the fuel line at the point where the electrolysis system of the present invention is connected showing how the hydrogen and oxygen gases are injected into the fuel line transverse to the flow of liquid fuel.

FIG. 7 is a view of the hydrogen and oxygen gases encapsulated by liquid fuel as it is fed into the fuel injector nozzle and injected into the combustion chamber of the engine.

FIG. 8 is flow diagram showing how the various components of the electrolysis system of the present invention are arranged and connected to the internal combustion engine.

FIG. 9 is a cross-sectional view of the flashback preventer used in the present invention.

FIG. 10 is a diagrammatic view illustrating essential components of a system that automatically refills the water inside the electrolysis chamber of the present invention.

### DETAILED DESCRIPTION OF THE PREFERRED EMBODIMENTS

Reference will now be made to the drawings in which various elements of the present invention will be given numerical designations and in which the invention will be discussed so as to enable one skilled in the art to make and use the invention.

The present invention comprises an electrolysis system that generates and delivers hydrogen gas and oxygen gas to an internal combustion engine. Electrolysis is a well known process whereby an electrical current is passed through a water-based electrolyte solution. The electrical current splits the water molecules in the solution releasing hydrogen gas and oxygen gas. In the present invention, the hydrogen gas and oxygen gas are pressurized before being injected into the fuel line of an internal combustion engine to enhance its performance while reducing the emissions of toxic substances.

Application of the present invention is within vehicles that are powered by an internal combustion engine. This invention may be used with a variety of vehicles, including conventional passenger cars having a gasoline engine, commercial trucks that use diesel engines, and specialized vehicles such as tractors, train locomotives, ships, and aircrafts that are powered by internal combustion engines. However, the preferred embodiment described herein has been configured to meet the needs of a commercial truck powered by a diesel engine. It will be appreciated by those skilled in the art that the principles of this invention may be applied to other types of vehicles and internal combustion engines without departing from the spirit of the present invention.

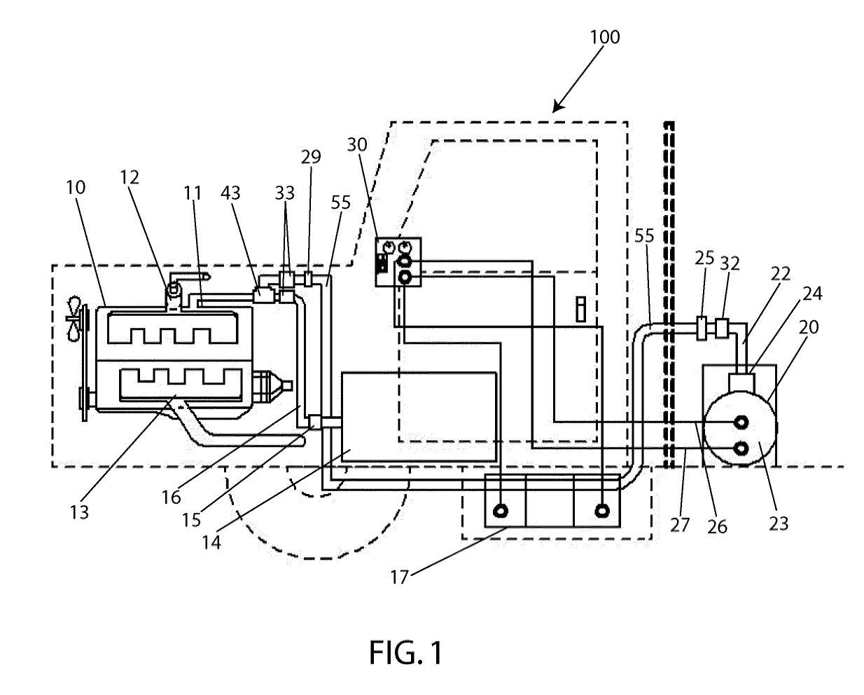

FIG. 1 shows a commercial truck 100 powered by an internal combustion engine 10 of the piston type in which fuel is ignited within the combustion chamber 31. Mounted to the engine 10 are a fuel intake manifold 11, an air intake 12, and an exhaust manifold 13. The engine also includes a fuel tank 14 from which gasoline or other fuel is drawn through the fuel line 16 by the fuel pump 15. The engine 10 also includes a battery 17 as a source of electrical current to power various components of the engine 10 and vehicle 100.

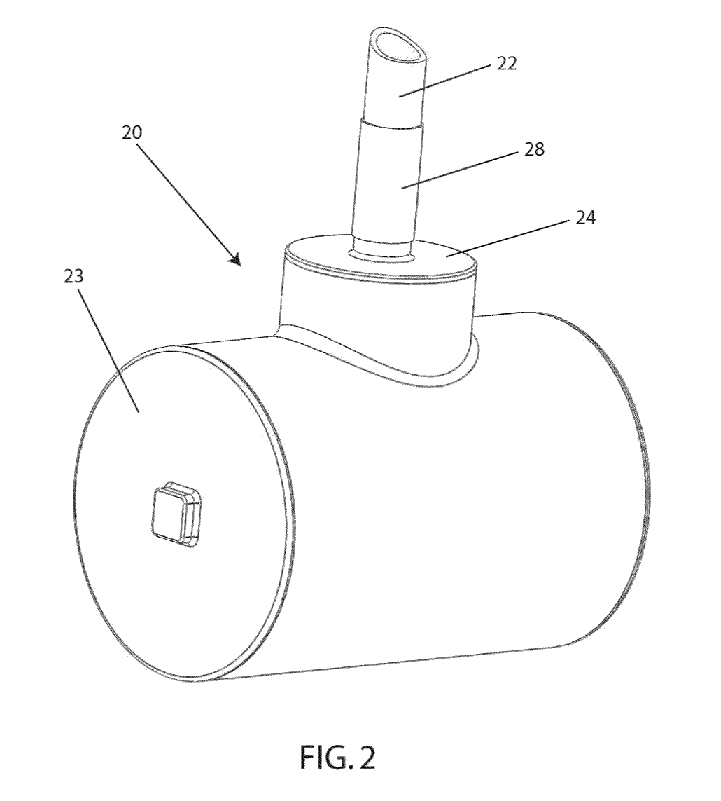

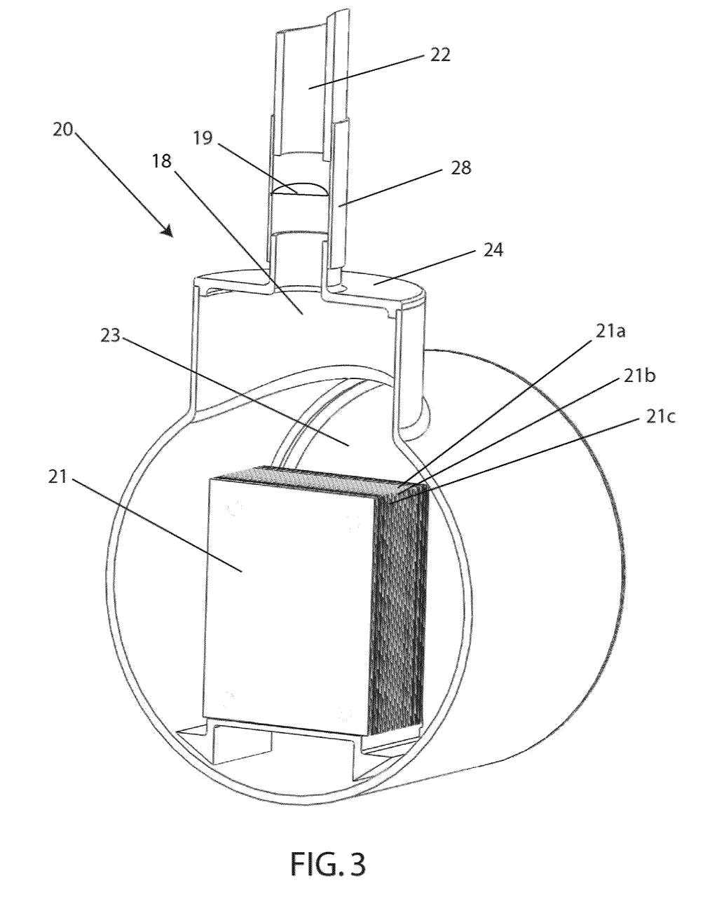

The main component of the present invention is an electrolysis chamber 20, which is shown in FIG. 1 and in greater detail in FIGS. 2 and 3. The electrolysis chamber 20 has side caps 23 and a top cap 24 that are sealed and can withstand high pressure. The electrolysis chamber 20 is waterproof and made of a chemically and electrically inert material, such as high impact plastic. It has been found that a polyvinyl chloride plastic (PVC) is a suitable material for the electrolysis chamber 20. This type of plastic does not absorb liquid or gas, is very dense and strong, can withstand cracking even in extremely cold temperatures, and is easy to solvent weld or glue. However, other materials with similar characteristics may also be used if they provide adequate results.

An array of stainless steel plates 21 bundled together equally spaced, and parallel to each other is located within the electrolysis chamber 20. Some of the stainless steel plates are considered to be cathodes 21a while other stainless steel plates are anodes 21b and the other stainless steel plates are neutral plates 21c. A wire 26 electrically connected to the anodes 21b runs through the control box 30 and connects with the positive pole of the battery 17. A second wire 27 is in electrical contact with the cathodes 21a and leads to the negative ground pole of the battery 17, or vehicle frame, if grounded.

It should be noted that the neutral plates 21c do not have to be constructed out of stainless steel. The neutral plates 21c can be constructed out of plastics, composites, or a metal other than stainless steel. However, both the cathodes 21a and anodes 21b should be conductors or made of conductive material such as metal, since electrical conduction through these elements is necessary for the electrolysis process. Ideally, the cathodes 21a and anodes 21b should be made of a pure noble metal, such as nickel, platinum, palladium, rhodium, or titanium. However, though noble metals can enhance the electrolysis process by lending electrons to enhance current flow through the electrolyte solution, they tend to be costly and difficult to find. In the present invention, stainless steel is used due to its cost effectiveness and wide availability in the marketplace.

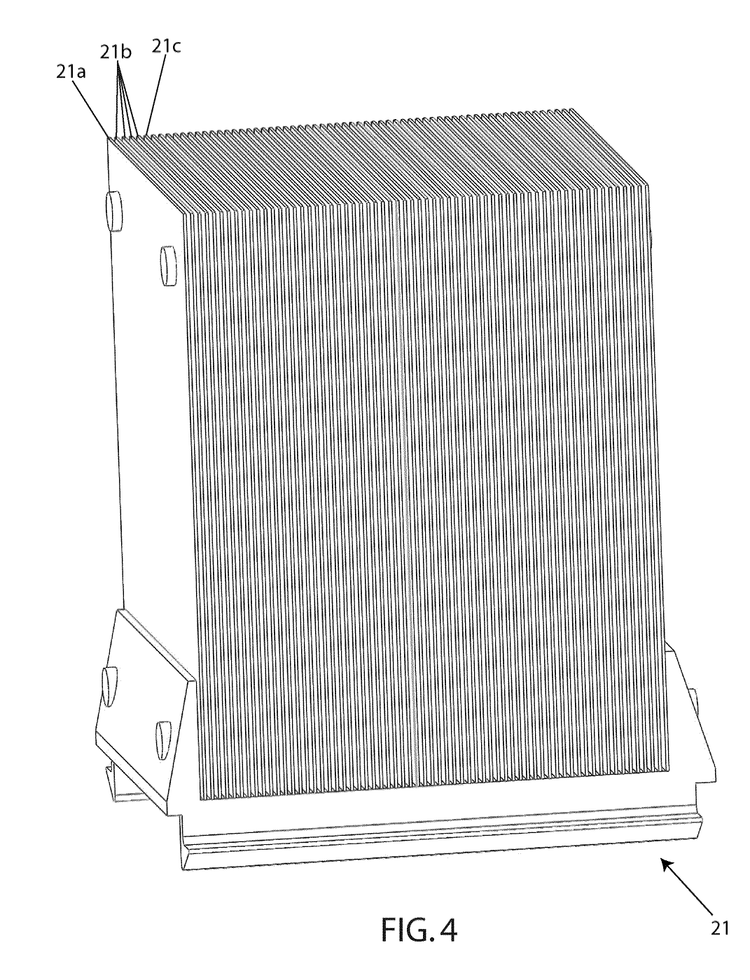

As shown in FIG. 4, the stainless steel plates 21a, b, and c are approximately 0.030 inches thick and each is spaced apart about 0.060 inches from the others. A single cathode 21a is about 0.5 inches apart from an anode 21b and with 4 neutral stainless steel plates 21c in between.

As shown in FIG. 3, the electrolysis chamber 20 contains an aqueous electrolyte solution 18, which is normally filled to a level 19 above the top of the array of stainless steel plates 21. In order for electrical current to be passed between the stainless steel plates 21a, b, and c, the electrolyte solution 18 is preferably a liquid mixture of potassium hydroxide (KOH) and water. The preferred concentration is 0.1% KOH by weight, though it can be appreciated that other concentrations may also be acceptable if they produce adequate results. Only the water component of the electrolyte solution 18 requires regular replenishment while the KOH generally only needs replenishment after years of normal use.

As shown in FIGS. 2 and 3, attached to the top cap 24 of the electrolysis chamber 20 is a pipe 28 made from clear plastic to allow the operator to see if there is sufficient quantity of the electrolyte solution 18. The proper operating level 19 of the electrolyte solution 18 should fall within the clear plastic pipe 28. Ideally, the level 19 of the electrolyte solution 18 should be on the top half of the clear plastic pipe 28. If the electrolyte solution 18 is running low, the operator replenishes the system with more water only.

As shown in FIG. 3, directly above the electrolyte solution 18 is the gas accumulation zone 22 where the hydrogen gas and oxygen gas are collected before being injected into the fuel line 16. The size of the gas accumulation zone 22 depends on the size of the engine 10 and vehicle 100.

A pressure control valve 25 is located at the end of the gas accumulation zone 22. The pressure control valve 25 is a commonly used hydraulic component that passes flow of fluid or gas in one direction at a predetermined pressure. In the present invention, the pressure control valve 25 is configured to pass the hydrogen gas and oxygen gas from the gas accumulation zone 22 into the fuel line 16. The pressure control valve 25 has a pre-set pressure rating so that the hydrogen gas and oxygen gas can flow only when the pressure across the valve 25 exceeds a rated value. In the present invention, the rated value of the pressure control valve 25 is the pressure inside the fuel line 16. Therefore, the produced hydrogen gas and oxygen gas will flow out of the electrolysis chamber 20 into the fuel line 16 when the pressure of the gases in the gas accumulation zone 22 exceeds the pressure of the liquid fuel 41 inside the fuel line 16.

A flow control device 29 is attached to the gas line 55 after and inline with the pressure control valve 25. The flow control device 29 regulates the flow characteristics of the hydrogen and oxygen gases through the gas line 55 and into the fuel line 16. The present invention regulates the flow characteristics of the hydrogen and oxygen gases based on the size and power output of the engine 10, the size of the electrolysis chamber 20, and the amount of hydrogen gas and oxygen gas needed by the engine 10 at any particular time.

The operation of the present invention can now be described. Initially, when the engine 10 is turned off, there is no electrical power and so no electrical current running to the array of stainless steel plates 21, no electrolysis taking place, no hydrogen and oxygen gases being produced, and the gas pressure inside the electrolysis chamber 20 is low. When the vehicle operator turns on the engine 10 and starts the electrolysis system, the control box 30 begins sending electrical current to the array of stainless steel plates 21.

When electrical current is applied and passed through the electrolyte solution 18 by the array of stainless steel plates 21, the water in the electrolyte solution 18 is decomposed through electrolysis to produce hydrogen gas and oxygen gas, which rises upwardly above the electrolyte solution 18 and collects in the gas accumulation zone 22. As the hydrogen gas and oxygen gas are collected in the gas accumulation zone 22, the pressure is built up. When the gas pressure in the gas accumulation zone exceeds the pressure in the fuel line 16, the hydrogen gas and oxygen gas are injected into the fuel line 16 (see arrows 110).

It has been found that it generally takes about 1-10 minutes for the gas accumulation zone 22 to pressurize. Therefore, the operator of the vehicle may experience a noticeable increase in power approximately 1-10 minutes after starting the electrolysis system. Thereafter, the electrolysis system should remain operating and provide benefits of electrolysis throughout the rest of the trip.

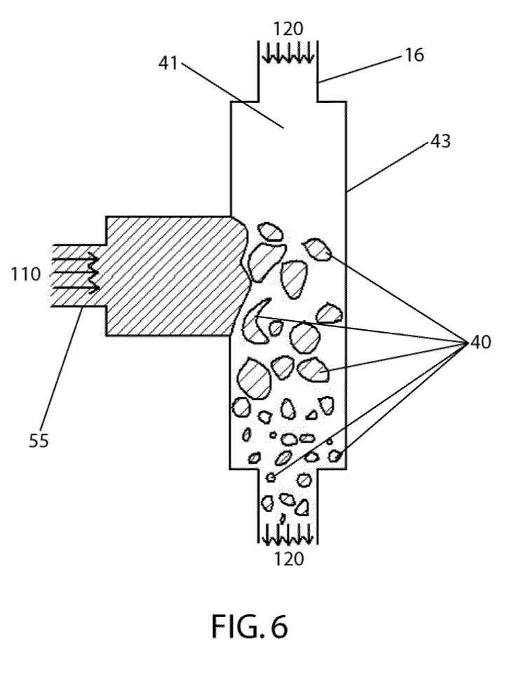

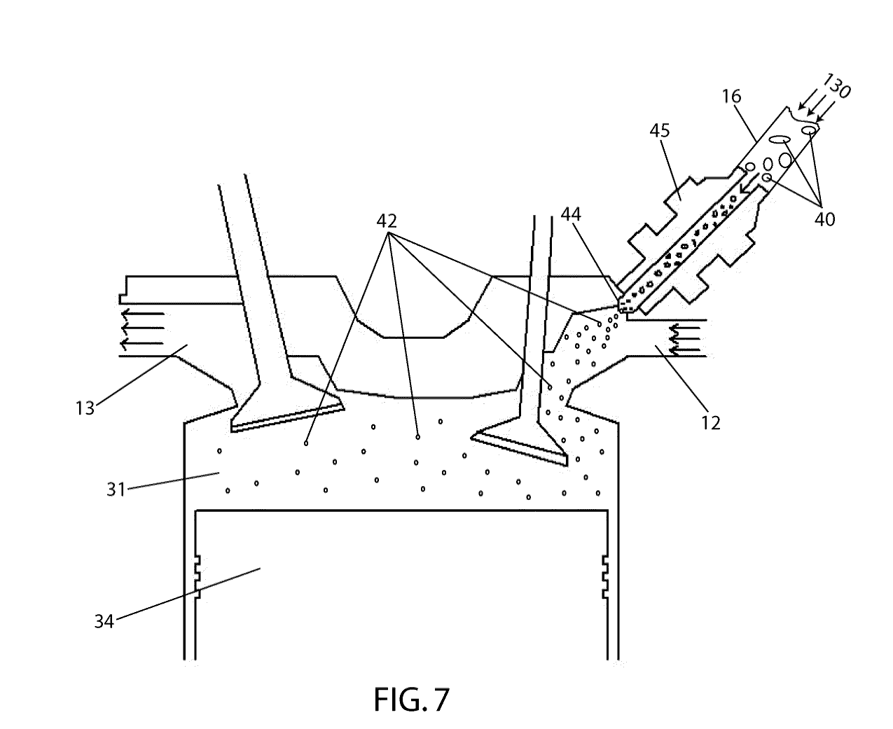

As shown on FIGS. 6 and 7, once in the fuel line 16, the hydrogen gas and oxygen gas are pushed with the flow of the fuel 41 (see arrows 120) into the combustion chamber 31 of the engine 10. As the gases travel to the combustion chamber 31, the gases are broken up into bubbles 40 that are evenly mixed within the liquid fuel 41. The bubbles 40 of hydrogen gas and oxygen gas in the fuel line 16 are encapsulated by the liquid fuel 41 before they are injected into the combustion chamber 31 of the engine 10.

The fuel injectors 45 deliver liquid fuel 41 into the combustion chamber 31 towards the end of the compression stroke of the piston 34. When the liquid fuel 41 is injected into the combustion chamber 31, it is atomized into very fine droplets 42. In the present invention, the hydrogen and oxygen gases are evenly mixed within the liquid fuel 41 therefore; the majority of the atomized fine droplets 42 that are injected into the combustion chamber 31 are very fine bubbles of hydrogen and oxygen gases encapsulated by liquid fuel 41, as shown in FIG. 7.

Normally, when hydrogen and oxygen gases are not introduced into the liquid fuel 41, the fine droplets 42 are made of pure liquid fuel 41 that vaporize due to heat transfer from the compressed air in the combustion chamber 31. Due to continued heat transfer from hot air to the liquid fuel 41, the temperature reaches a value higher than the self-ignition temperature of the fuel. This causes the vaporized fuel 41 to spontaneously ignite and initiate the combustion process.

When hydrogen and oxygen gases are introduced into the liquid fuel 41 as in the present invention, the fine droplets 42 become fine bubbles of hydrogen gas and oxygen gas encapsulated by liquid fuel 41. The self-ignition temperature of the hydrogen and oxygen gases is lower than that of the liquid fuel 41. Hence, the heat transfer from the compressed air in the combustion chamber 31 causes the fine droplets 42 of hydrogen and oxygen gases to ignite spontaneously before the liquid fuel 41 can completely vaporize. The liquid fuel, in essence, serves to maintain the combustion temperature lower than if the gases were not encapsulated with liquid fuel 41. Therefore, the operating temperature of the engine using the present invention is maintained within its design specifications.

Prior art, such as those taught in the '493 patent and the '954 patent, as described above, introduce the hydrogen and oxygen gases directly into the combustion chamber 31 without first being encapsulated by liquid fuel 41. The hydrogen and oxygen gases are mixed with the air and fuel inside the combustion chamber 31 prior to ignition. The resulting operating temperature is hotter as is the exhaust released. The higher temperatures lead to damage and quicker deterioration of the engine 10. The manner in which the present invention encapsulates the hydrogen and oxygen gases with liquid fuel before ignition results in lower operating and exhaust temperatures that significantly improve the life of the engine 10.

Encapsulation of the hydrogen and oxygen gases with liquid fuel has not been duplicated by any known prior art. In fact, U.S. Pat. No. 5,007,381 teaches the injection of the gases directly into the combustion chamber by an auxiliary injection nozzle that is completely independent of the liquid fuel injection nozzle. Furthermore, U.S. Pat. No. 5,546,902 teaches a system wherein the gas travels through a needle-like body having formed therein the fuel line. In both prior art, the gases are delivered to the combustion chamber separate from the liquid fuel and without first being encapsulated by the liquid fuel.

One of the results of having hydrogen and oxygen gases in the combustion chamber 31 at the time of combustion is higher velocity of flame propagation that ultimately increases the engine power output. In addition, since in the present invention, the fine droplets 42 injected into the combustion chamber 31 are mostly hydrogen and oxygen gases encapsulated by liquid fuel 41, less liquid fuel is used per combustion cycle than in traditional engines where the fine droplets 42 are pure liquid fuel 41. Hence, the introduction of hydrogen and oxygen gases directly into the fuel line by the present invention has shown to improve the power output of the engine and increase the fuel efficiency by approximately 35%.

In order to optimize the mixing of the hydrogen and oxygen gases in the liquid fuel 41, the present invention pressurizes the gases and controls their flow characteristics prior to injecting them into the fuel line 16. Typical pressure inside the fuel line 16 is between 15-20 psi. In order to inject the gases into the fuel line, the pressure of the gases in the gas accumulation zone 22 must be at least the same pressure as the pressure inside the fuel line 16. The present invention pressurizes the gas to higher levels than that in the fuel line 16 so that it can be thoroughly injected into the flowing liquid fuel. As shown by arrows 110 in FIG. 6, the hydrogen and oxygen gases are injected transversely into the fuel line 16 through a tee coupling 43 with a predetermined flow rate regulated by the flow control device 29. The pressurized transverse injection allows the gases to be injected across the fuel line 16, as shown in FIG. 6. As the gases are introduced across the fuel line 16, the transverse flow of the liquid fuel 41 (see arrows 120) pushes the gases in the direction of the flow and breaks it up into bubbles 40 that are subsequently mixed within the flowing liquid fuel 41 in the fuel line 16.

FIG. 7 shows the gas bubbles 40 encapsulated by liquid fuel 41 as they are fed into the nozzle 44 of the fuel injectors 45 (see arrows 130). The nozzle 44 subsequently atomizes the mixture of liquid fuel 41 and gas bubbles 40 so that the fine droplets 42 that are finally injected into the combustion chamber 31 are fine bubbles of hydrogen gas and oxygen gas encapsulated by liquid fuel 41.

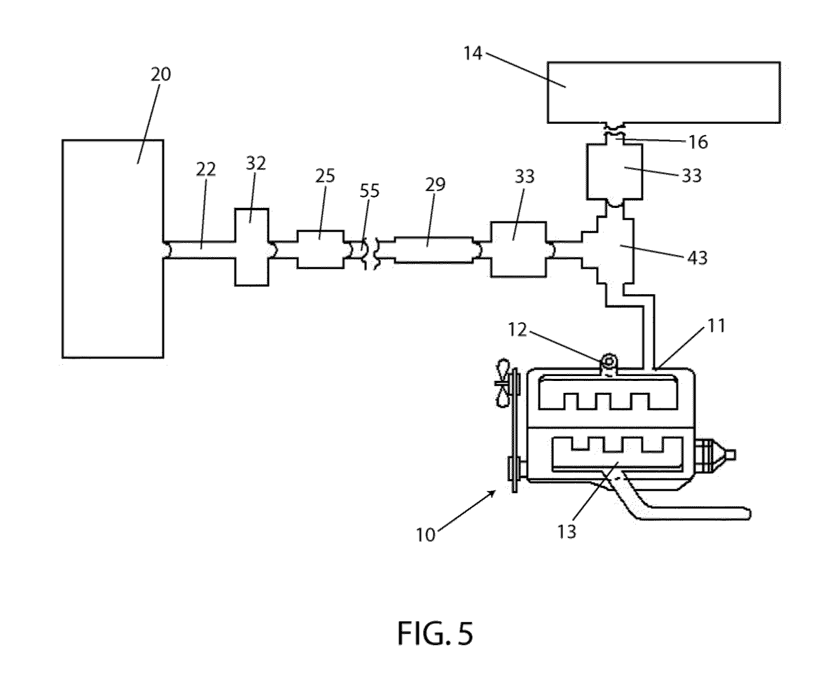

The longer the distance traveled by the hydrogen and oxygen gases inside the fuel line 16, the greater the tendency for gases to form larger gas bubbles or completely separate themselves from the liquid fuel. Hence, the longer the distance between the nozzle 44 and the tee coupling 43, the less mixing and more separation of the gases from the liquid fuel. If a poor mixture of liquid fuel 41 and gases are introduced into the nozzle 44, then the fine droplets 42 that are injected into the combustion chamber 31 are mostly a combination of pure liquid fuel droplets and pure gas droplets without encapsulation by liquid fuel. Such droplets injected into the combustion chamber 31 increases the operating temperatures of the engine as if the gases and liquid fuel were separately injected into the combustion chamber 31 as in the various prior art. Therefore, the distance between the nozzle 44 and the tee coupling 43 must be optimized. In the present invention, it has been shown that the optimum location for the tee coupling 43 is at the end of the fuel line 16 and immediately before the fuel intake manifold 11, as shown in FIG. 5.

U.S. Pat. No. 6,311,648 teaches the injection of the hydrogen and oxygen gases into the fuel tank of a vehicle at atmospheric pressures. The fuel pump then directs the gases and liquid fuel through the fuel line. This configuration maximizes the time and distance of the gases inside the fuel line thus causing the liquid fuel and the gases to be poorly mixed before being injected into the combustion chamber. Effectively, introducing the hydrogen and oxygen gases directly into the fuel tank rather than the fuel line is the same as injecting the hydrogen and oxygen gases directly into the combustion chamber without its encapsulation by liquid fuel. In addition, introducing the gases into the fuel tank increases the possibility that the gases will separate from the liquid fuel before it enters the fuel line and collect within the fuel tank. Such accumulation of hydrogen and oxygen gases in the vehicle's fuel tank can be extremely hazardous and may result in an explosion.

Another important aspect of the present invention is the on-demand production of the hydrogen and oxygen gases as needed by the engine at any particular time. When the operator of the vehicle starts the electrolysis system, the control box 30 begins sending electrical current to the array of stainless steel plates 21 so that the production of the hydrogen and oxygen gases may begin. Once sufficient hydrogen and oxygen gases are produced to pressurize the gas accumulation zone 22 and open the pressure control valve 25, the control box 30 begins regulating the amount of electrical current it sends to the array of stainless steel plates 21. The amount of hydrogen and oxygen gases produced by the present invention is directly proportional to the amount of electrical current passed through the array of stainless steel plates 21.

The electrolysis chamber 20 can be located anywhere in the vehicle, either in the back of the vehicle or near the engine 10. However, the gas line 55 must extend from the electrolysis chamber 20 to the tee coupling 43 that connects to the fuel line 16. In essence, regardless where the electrolysis chamber 20 is located, the hydrogen and oxygen gases can only be injected into the fuel line 16 at the tee coupling 43 that is placed at the optimum location, close to the fuel intake, as shown in FIG. 5.

After the electrolysis system is started and the pressure control valve 25 is opened to inject the hydrogen and oxygen gases into the fuel line 16, the control box 30 begins monitoring several measurable conditions of the engine 10 and vehicle 100, such as revolutions per minute (RPM) of the engine 10, speed of the vehicle 100, temperature of the engine 10, and/or displacement of the accelerator pedal by the operator of the vehicle 100. The various data points allow the control box 30 to determine how much hydrogen and oxygen gases are needed by the engine 10. Based on the needs of the engine 10, the control box 30 regulates the amount of electrical current sent to the array of stainless steel plates 21 thus regulating the amount of hydrogen and oxygen gases injected into the engine 10.

For example, when the RPM is high, the velocity of the vehicle 100 is low, and the displacement of the accelerator pedal is high, the control box 30 may determine that the vehicle 100 is moving uphill with a heavy load. Thus, the control box 30 would maximize the amount of hydrogen and oxygen production. On the other hand, if the RPM is high, the velocity of the vehicle 100 is high, and the displacement of the accelerator is low, the control box 30 may determine that the vehicle 100 is moving downhill. Thus, the control box 30 would minimize or even cease the production of hydrogen and oxygen gases.

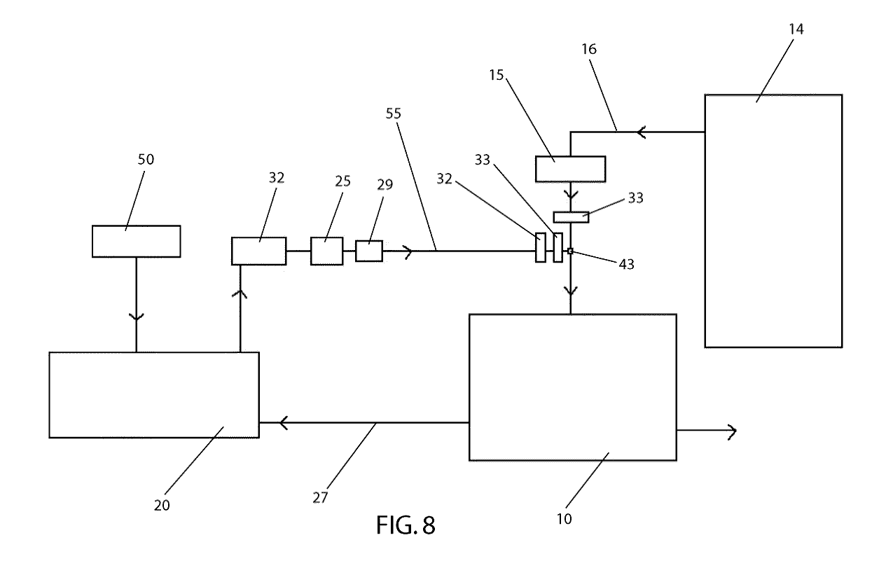

As a safety feature, backflash preventers 32 and check valves 33 are connected in-line with the pressure control valve 25, fuel line 16, and gas accumulation zone 22 to prevent accidental explosion of the hydrogen and oxygen gases in the event of engine backfire. FIG. 8 shows a comprehensive flow chart of how all the components of the electrolysis system are connected or attached together. A check valve 33 is a commonly used hydraulic device that allows the flow of fluid or gas in one direction but acts as a check to prevent the flow in the reverse direction. The check valves 33 in the present invention are used to prevent backflow of the gases or liquid fuel from the fuel line 16 back into the electrolysis chamber 20.

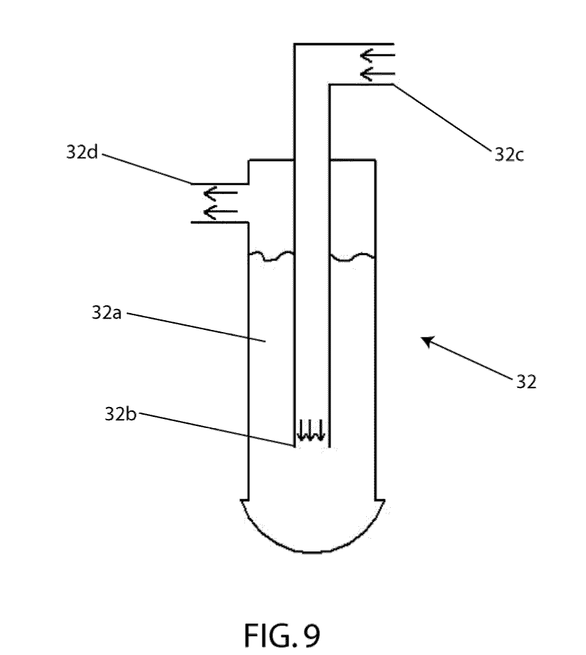

As shown in FIG. 9, a backflash preventer 32 is a hydraulic device having water 32a or other liquid inside into which the open end of a hose 32b connected to the inlet port 32c is immersed. As the hydrogen gas and oxygen gas are fed into the inlet port 32c, they are released into the water 32a by the hose 32b and bubble upward out of the water 32a and to the outlet port 32d. Should a backflash occur, the ignited gas or fire will enter the backflash preventer 32 where it would be extinguished by the water 32a.

Another important safety feature of the present invention is the location of the gas accumulation zone 22. Placing the gas accumulation zone 22 on the top side of the electrolysis chamber 20 ensures that all the hydrogen gas and oxygen gas produced are fed and collected within the gas accumulation zone 22 for usage. Placing the gas accumulation zone 22 on the sides of the electrolysis chamber 20, as is done in some of the prior art, prevents all of the gases produced from being properly collected for usage by the system. Gas always flows upward. If the gas accumulation zone 22 is not directly above, then the gas flowing upward will have to find its way sideways and into the gas accumulation zone 22. This increases the risk that the combustible gases will collect somewhere other than in the gas accumulation zone 22 and pose a danger of explosion.

Another important safety feature of the present invention is the release of any significant excess or unused hydrogen gas and oxygen gas that is left inside the electrolysis chamber 20 after the electrolysis system or engine is turned off. As hydrogen gas and oxygen gas molecules are produced by the electrolysis system, they are collected within the gas accumulation zone 22 until the pressure is sufficient to inject them into the fuel line. When the electrolysis system is turned off or deactivated, it stops producing any more hydrogen gas and oxygen gas molecules but the gas molecules already in the gas accumulation zone 22 can pose a danger of explosion if left there in any significant quantity. The present invention utilizes valves that open when the system is turned off or deactivated. When the valves open, the hydrogen gas and oxygen gas molecules are allowed to escape into the outside atmosphere or into the engine.

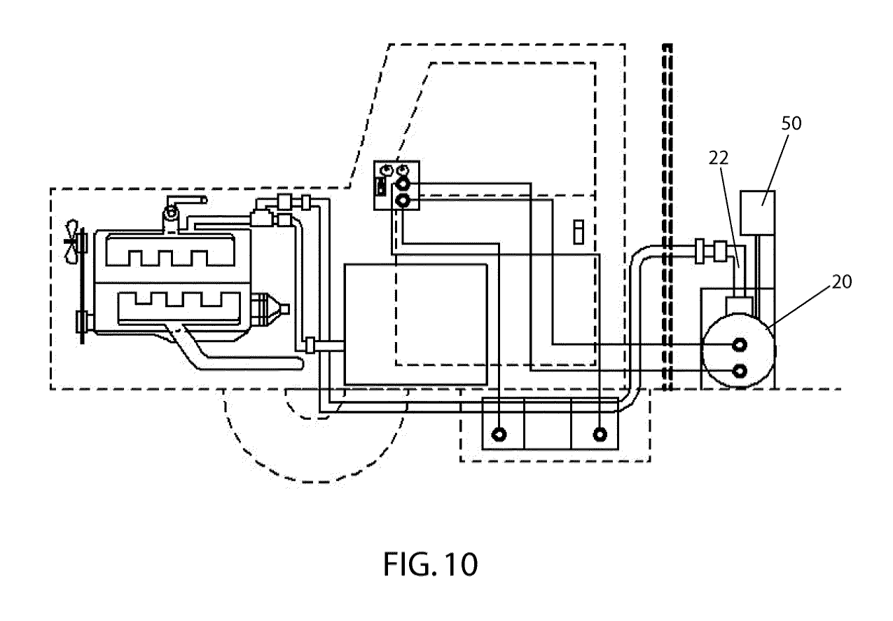

As the hydrogen and oxygen gases are produced by the present invention, the only element that gets used up during the electrolysis process is the water that is in the electrolyte solution 18. As the water is used up, the amount of electrolyte solution 18 in the electrolysis chamber 20 declines and needs to be replenished. As shown in FIG. 10, an embodiment of the present invention includes a water reservoir 50 to hold a supply of water and includes the means to refill the electrolyte solution 18 in the electrolysis chamber 20 with water from the water reservoir 50. It is therefore another advantage of the present invention that it extends the length of time during which system can operate without service by the operator.

It is understood that the described embodiments of the invention are illustrative only, and that modifications thereof may occur to those skilled in the art. Accordingly, this invention is not to be regarded as limited to the embodiments disclosed, but to be limited only as defined by the appended claims herein.

What is claimed is:

1. An electrolysis system for producing hydrogen gas and oxygen gas molecules for enhancing the performance of an internal combustion engine, said electrolysis system comprising:
an electrolysis chamber;
an electrolyte solution comprising water and an electrolyte and that fills the inside of said electrolysis chamber;
a plurality of metal plates placed within said electrolysis chamber and immersed in said electrolyte solution;
an electrical power source for electrically charging said metal plates to facilitate the electrolytic separation of said electrolyte solution into said hydrogen gas and oxygen gas molecules;
a gas accumulation zone located above the electrolyte solution;
a valve hydraulically connected to said gas accumulation zone;
a fuel line that conveys liquid fuel into said internal combustion engine;
means for opening said valve when the pressure inside said gas accumulation zone is higher than the pressure inside said fuel line whereby said hydrogen gas and oxygen gas molecules are injected into said fuel line; and
a flow control device that regulates the flow characteristics of said hydrogen gas and oxygen gas molecules as they are injected into said fuel line.

2. The electrolysis system of claim 1 further comprising a means for preventing a flashback explosion.

3. The electrolysis system of claim 2 wherein said means for preventing a flashback explosion comprises:
a flashback preventer chamber containing a quantity of liquid;
an inlet port through which said hydrogen gas and oxygen gas molecules are fed;
a hose connected to said inlet port and having a free end that extends downwardly into said flashback preventer chamber, wherein said hose is positioned such that when said quantity of liquid fills said flashback preventer chamber, said quantity of liquid reaches a level sufficient to cover said free end of said hose; and
an outlet port located above said quantity of liquid and through which said hydrogen gas and oxygen gas molecules exit.

4. The electrolysis system of claim 1 further comprising a means for controlling the amount of electric charge to said plurality of metal plates wherein the amount of said hydrogen gas and oxygen gas molecules injected into said fuel line increases as said electric charge is increased.

5. The electrolysis system of claim 1 wherein said plurality of metal plates are arranged in a pattern comprising:
a first outer plate being positively charged;
a second outer plate being negatively charged; and
at least 4 neutral plates spaced between said first outer plate and said second outer plate.

6. The electrolysis system of claim 5 wherein said neutral plates are not made of metal.

7. The electrolysis system of claim 1 further comprising:
a level sensor with means for sensing a level of electrolyte solution within said electrolysis chamber;
a water reservoir containing water; and
means for automatically refilling said electrolysis chamber with water from said water reservoir when said level sensor indicates said level of electrolyte solution to be low.

8. The electrolysis system of claim 1 further comprising a clear pipe attached to said electrolysis chamber at the location where the proper level of said electrolyte solution must reach whereby the operator can visually see if the proper amount of said electrolyte solution is present inside said electrolysis chamber.

9. A method of producing hydrogen gas and oxygen gas molecules for enhancing the performance of an internal combustion engine, said method comprising:
providing an electrolysis system for generating said hydrogen gas and oxygen gas molecules from an electrolyte solution comprising water and an electrolyte;
collecting said hydrogen gas and oxygen gas molecules inside a gas accumulation zone that is hydraulically connected to a valve then to a fuel line that conveys liquid fuel into said internal combustion engine;
opening said valve when the pressure inside said gas accumulation zone is higher than the pressure inside said fuel line whereby said hydrogen gas and oxygen gas molecules are injected from said gas accumulation zone into said fuel line; and
controlling the flow characteristics of said hydrogen gas and oxygen gas molecules as they are injected into said fuel line.

10. The method of producing hydrogen gas and oxygen gas molecules of claim 9 further comprising replenishing said electrolyte solution with water from a water reservoir if the level of said electrolyte solution is at or less than a predetermined refill level.
